(19) United States
(12) Patent Application Publication
(10) Pub. No.: US 2010/0242760 A1
(43) Pub. Date: Sep. 30, 2010

(54) Apparatus and method for mounting printing plate

(75) Inventors: Shuichi Otsuka, Ashigarakami-gun (JP); Mitsuru Mushano, Ashigarakami-gun (JP); Masashi Norimatsu, Ashigarakami-gun (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/662,074

(22) Filed: Mar. 30, 2010

(30) Foreign Application Priority Data
Mar. 31, 2009 (JP) 2009-084732

(51) Int. Cl. B41F 27/00; B41L 3/02

(52) U.S. Cl. 101/382.1; 101/486

(57) ABSTRACT

A printing plate mounting apparatus includes a mounting mark information acquiring device which acquires mounting mark information formed on each of a plate-making drum provided in a plate-making apparatus, and a printing drum provided in a printing apparatus that prints an image on an object to be printed; an image creating device which creates an image of each color; a first calculating device which respectively calculates a size of each printing plate corresponding to the color image and a mounting position of the printing plate on each of the plate-making drum and the printing drum; a second calculating device which calculates a position of a plate-making positioning mark according to the mounting mark, and also calculates a position of a printing positioning mark according to the mounting mark; and a printing device which prints the plate-making positioning mark and the printing positioning mark on a printing plate support.

### BACKGROUND OF THE INVENTION

1. Field of the Invention

The present invention relates to an apparatus and method for mounting a printing plate, and more particularly, to an apparatus and method for mounting a printing plate which improves the accuracy of a mounting position when a flexographic printing plate is mounted on a plate-making apparatus and a printing apparatus.

2. Description of the Related Art

Japanese Patent Application Laid-Open No. 2002-19323 discloses a flexographic laminate where a printing plate member or a printing plate member and an elastic support adhered together are arranged only on a portion where printing is to be performed after an image is formed on the printing plate member.

In flexographic printing, printing is mostly performed only on a given portion of an object to be printed (for example, cardboard). Also, images of different colors are usually printed on different positions.

A flexographic printing plate (a press plate) is a thick resin plate, and its cost per unit area is high. It is also necessary to remove a great thickness (for example, 500 μm) of resin in a non-image region of the flexographic printing plate where an image is not formed. Thus, it takes processing time and energy to form the flexographic printing plate. Also, when there is a large non-image region, wastes are produced in large quantities, which is not preferable from the environmental viewpoint. Therefore, it has been proposed to perform printing by arranging the flexographic printing plate only on a region of a printing drum (a cylinder) where an image is formed.

When printing is performed by arranging the flexographic printing plate only on the region where the image is formed, the flexographic printing plate needs to be mounted on the printing drum with high position accuracy. When printing is performed by overlapping images by use of flexographic printing plates corresponding to a plurality of colors, high position accuracy is also required for the relative positions of the flexographic printing plates corresponding to the respective colors.

However, it is difficult to mechanically perform positioning of the flexographic printing plate. Conventionally, positioning is performed by adjusting the mounting position of the flexographic printing plate with the flexographic printing plate being fixed to the printing drum with an adhesive or the like. Thus, there is a problem that it takes time to mount the flexographic printing plate. There is also a problem that register accuracy in the positioning is low, thereby affecting an image quality.

Also, the flexographic printing plate is flexible and easily expands and contracts. Therefore, it is necessary to equalize the degree of expansion and contraction at the time of making the plate (when the flexographic printing plate is mounted on an exposure drum of a plate-making apparatus (an exposure apparatus)) and the degree of expansion and contraction at the time of performing printing (when the flexographic printing plate is mounted on a printing drum of a printing apparatus).

The present invention has been made in view of such circumstances, and it is an object of the present invention to provide an apparatus and method for mounting a printing plate capable of improving the efficiency of a printing plate mounting operation and the quality of a printed image by improving the accuracy of the mounting position of the printing plate at the time of making the printing plate and performing printing.

### SUMMARY OF THE INVENTION

In order to achieve the above object, a printing plate mounting apparatus according to a first aspect of the present invention includes: a mounting mark information acquiring device which acquires information of a mounting mark that is formed on each of a plate-making drum provided in a plate-making apparatus that makes a printing plate and a printing drum provided in a printing apparatus that prints an image on an object to be printed by using the printing plate; an image creating device which creates an image of each color from the image to be printed on the object to be printed; a first calculating device which respectively calculates a size of each printing plate corresponding to the image of each color and a mounting position of the printing plate on each of the plate-making drum and the printing drum; a second calculating device which calculates a position of a plate-making positioning mark for performing positioning according to the mounting mark formed on the plate-making drum based on the mounting position of the printing plate on the plate-making drum, and also calculates a position of a printing positioning mark for performing positioning according to the mounting mark formed on the printing drum based on the mounting position of the printing plate on the printing drum; and a printing device which prints the plate-making positioning mark and the printing positioning mark on a support on which the printing plate is mounted.

With the first aspect, the position of the plate-making positioning mark for performing positioning according to the mounting mark formed on the plate-making drum of the plate-making apparatus and the position of the printing positioning mark for performing positioning according to the mounting mark formed on the printing drum of the printing apparatus are printed on the support on which the printing plate calculated corresponding to the image of each color is mounted. Accordingly, the positioning can be easily and accurately performed at both the times of making the plate and performing printing.

A printing plate mounting apparatus according to a second aspect of the present invention is the printing plate mounting apparatus according to the first aspect, wherein when the printing plate includes a plurality of printing plates, the second calculating device sets the plate-making positioning mark so as to increase an arrangement density of the plurality of printing plates on the plate-making drum.

A printing plate mounting apparatus according to a third aspect of the present invention is the printing plate mounting apparatus according to the first or second aspect, wherein when the printing plate includes a plurality of printing plates, the second calculating device sets the plate-making positioning mark so that the plurality of printing plates are lined in a rotational direction of the plate-making drum.

With the second and third aspects, since the printing plates are arranged as described above, the scanning distance of a head which forms an image on the surfaces of the printing plates can be reduced. Accordingly, the printing plates can be made with an improved working efficiency.

A printing plate mounting apparatus according to a fourth aspect of the present invention is the printing plate mounting apparatus according to the first to third aspects, wherein the printing device prints on the support a mark that indicates a position to mount the printing plate.

With the fourth aspect, positioning at the time of mounting the printing plate on the support can be easily performed.

A printing plate mounting apparatus according to a fifth aspect of the present invention is the printing plate mounting apparatus according to the first to fourth aspects, further including: a size setting device which sets a size of a cushioning material which is mounted on the support based on the size of the printing plate, wherein the printing device prints on the support a mark that indicates a position to mount the cushioning material.

With the fifth aspect, positioning at the time of mounting the cushioning material on the support can be easily performed.

A printing plate mounting apparatus according to a sixth aspect of the present invention is the printing plate mounting apparatus according to the first to fifth aspects, further including: a material setting device which sets a material of the printing plate and a material of a cushioning material which is mounted on the support based on a type of the image and an area ratio that is a ratio between an area of the image and an area of the printing plate, wherein the printing device prints the material of the printing plate and the material of the cushioning material on the support.

With the sixth aspect, the size and material of the cushioning material can be automatically selected.

A method for mounting a printing plate according to a seventh aspect of the present invention includes: a mounting mark information acquiring step of acquiring information of a mounting mark that is formed on each of a plate-making drum provided in a plate-making apparatus that makes a printing plate and a printing drum provided in a printing apparatus that prints an image on an object to be printed by using the printing plate; an image creating step of creating an image of each color from the image to be printed on the object to be printed; a first calculating step of respectively calculating a size of each printing plate corresponding to the image of each color and a mounting position of the printing plate on each of the plate-making drum and the printing drum; a second calculating step of calculating a position of a plate-making positioning mark for performing positioning according to the mounting mark formed on the plate-making drum based on the mounting position of the printing plate on the plate-making drum, and also calculating a position of a printing positioning mark for performing positioning according to the mounting mark formed on the printing drum based on the mounting position of the printing plate on the printing drum; and a printing step of printing the plate-making positioning mark and the printing positioning mark on a support on which the printing plate is mounted.

A method for mounting a printing plate according to an eighth aspect of the present invention is the method for mounting a printing plate according to the seventh aspect, wherein in the second calculating step, when the printing plate includes a plurality of printing plates, the plate-making positioning mark is set so as to increase an arrangement density of the plurality of printing plates on the plate-making drum.

A method for mounting a printing plate according to a ninth aspect of the present invention is the method for mounting a printing plate according to the seventh or eighth aspect, wherein in the second calculating step, when the printing plate includes a plurality of printing plates, the plate-making positioning mark is set so that the plurality of printing plates are lined in a rotational direction of the plate-making drum.

A method for mounting a printing plate according to a tenth aspect of the present invention is the method for mounting a printing plate according to the seventh to ninth aspects, wherein in the printing step, a mark that indicates a position to mount the printing plate is printed on the support.

A method for mounting a printing plate according to an eleventh aspect of the present invention is the method for mounting a printing plate according to the seventh to tenth aspects, further including: a size setting step of setting a size of a cushioning material which is mounted on the support based on the size of the printing plate, wherein in the printing step, a mark that indicates a position to mount the cushioning material is printed on the support.

A method for mounting a printing plate according to a twelfth aspect of the present invention is the method for mounting a printing plate according to the seventh to eleventh aspects, further including: a material setting step of setting a material of the printing plate and a material of a cushioning material which is mounted on the support based on a type of the image and an area ratio that is a ratio between an area of the image and an area of the printing plate, wherein in the printing step, the material of the printing plate and the material of the cushioning material are printed on the support.

With the present invention, the position of the plate-making positioning mark for performing positioning according to the mounting mark formed on the plate-making drum of the plate-making apparatus and the position of the printing positioning mark for performing positioning according to the mounting mark formed on the printing drum of the printing apparatus are printed on the support on which the printing plate calculated corresponding to the image of each color is mounted. Accordingly, the positioning can be easily and accurately performed at both the times of making the plate and performing printing.

### BRIEF DESCRIPTION OF THE DRAWINGS

FIG. 1 is a block diagram illustrating a printing plate mounting apparatus according to one embodiment of the present invention;

FIG. 2 is a perspective view illustrating a plate-making apparatus (an exposure apparatus) according to one embodiment of the present invention;

FIG. 3 is a view illustrating a printing apparatus according to one embodiment of the present invention;

FIG. 4 is a perspective view of a printing drum of the printing apparatus according to one embodiment of the present invention;

FIG. 5 is a side view illustrating a printing plate structure 300 according to one embodiment of the present invention;

FIGS. 6A and 6B are plan views illustrating the printing plate structure 300 according to one embodiment of the present invention;

FIG. 7 is a plan view illustrating a state in which the printing plate structure 300 is mounted on an exposure drum 102;

FIG. 8 is a plan view illustrating a state in which the printing plate structure 300 is mounted on a printing drum 202; and

FIG. 9 is a flowchart illustrating a method for mounting a printing plate according to one embodiment of the present invention.

### DETAILED DESCRIPTION OF THE PREFERRED EMBODIMENTS

In the following, a preferred embodiment of an apparatus and method for mounting a printing plate according to the present invention will be described with reference to the accompanying drawings.

### [Configuration of Printing Plate Mounting Apparatus]

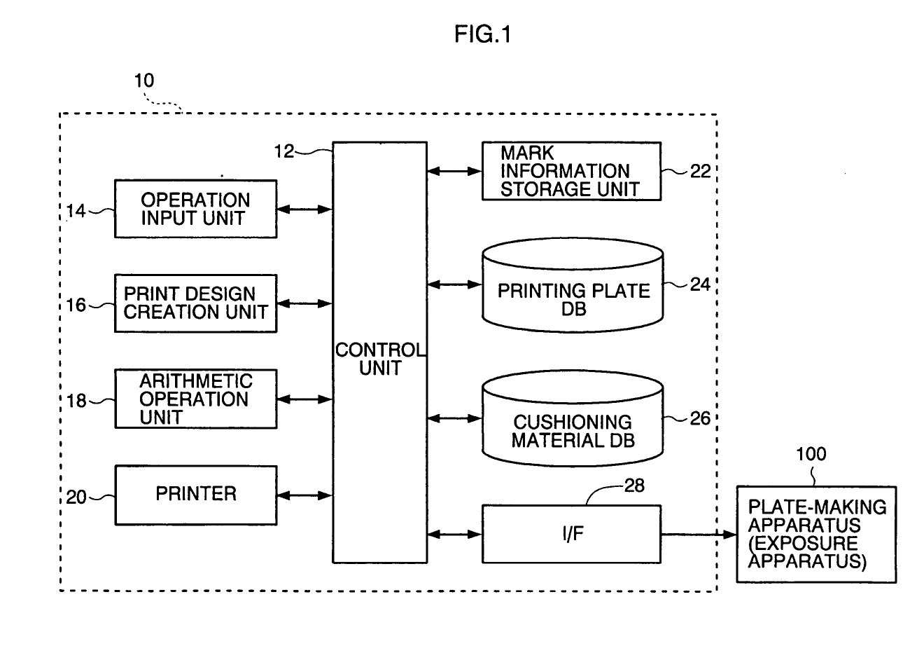

FIG. 1 is a block diagram illustrating a printing plate mounting apparatus according to one embodiment of the present invention.

As shown in FIG. 1, a printing plate mounting apparatus 10 according to the present embodiment includes a control unit 12, an operation input unit 14, a print design creation unit 16, an arithmetic operation unit 18, a printer 20, a mark information storage unit 22, a printing plate database (a printing plate DB) 24, a cushioning material database (a cushioning material DB) 26, and a connection interface (a connection I/F) 28.

The control unit 12 includes a CPU which outputs a signal to each unit of the printing plate mounting apparatus 10 to control the operation of each unit, and a memory which includes a storage area for storing a control program and a work area for the CPU to perform an arithmetic operation.

The operation input unit 14 is a switch which receives an operation input from a user. The control unit 12 interprets the operation content input to the operation input unit 14 by an operator, and controls each unit of the printing plate mounting apparatus 10.

The print design creation unit 16 creates the design of an image to be printed on an object to be printed (for example, a paper, a package of cardboard or the like, and a box surface) based on the input from the operation input unit 14. The print design creation unit 16 then decomposes the image into images of different ink colors used for printing (for example, black (K), cyan (C), magenta (M), and yellow (Y)) based on the created design of the image. A dedicated terminal for creating a print design may be provided separately from the printing plate mounting apparatus 10.

The mark information storage unit 22 stores mark information regarding mounting marks formed on the surfaces of an exposure drum 102 of a plate-making apparatus (an exposure apparatus) 100 that is used for making (exposing) a printing plate and a printing drum 202 of a printing apparatus 200. The mounting mark includes reference lines and auxiliary reference lines formed at predetermined intervals (for example, 300 mm) from the reference lines in a lattice pattern, for example. The mark information includes information indicating the position where the reference lines are formed, and the relative positions of the reference lines and the auxiliary reference lines (for example, an interval and a direction), for example. The mark information with respect to the printing apparatus 200 includes information indicating the relationship between the reference lines and the reference position of an object to be printed at the time of performing printing (for example, the edge corner of the object to be printed), and the mark information with respect to the exposure apparatus 100 includes information indicating the relationship between the reference lines and the original point of the position where the image is formed in the exposure apparatus 100 (a reference address position in the case of laser recording).

The mark information of the exposure apparatus 100 and the mark information of the printing apparatus 200 are stored in separate files. The exposure apparatus 100 used for making a printing plate 302 and the printing apparatus 200 used for performing printing by use of the printing plate 302 can be thereby independently selected. The mark information of the exposure apparatus 100 and the mark information of the printing apparatus 200 are stored by each model information of each of the exposure apparatus 100 and the printing apparatus 200.

The printing plate DB 24 stores the property data of the printing plate 302 (for example, information regarding a material and a hardness).

The cushioning material DB 26 stores the property data of a cushioning material 306 (for example, information regarding a material and a hardness). Here, the cushioning material 306 is an elastic member to be adhered to the rear surface of a support 304 to which the printing plate 302 is adhered to optimize a printing pressure applied to the surface of an object to be printed 212 by the printing plate 302.

The arithmetic operation unit 18 sets the size of the printing plate 302 corresponding to the image of each color created by the print design creation unit 16 based on the size of the image of each color. The arithmetic operation unit 18 also sets the size of the support 304 to which the printing plate 302 is adhered and the size of the cushioning material 306. The size of the support 304 is set to the same size as that of the printing plate 302 or a larger size than that of the printing plate 302. The size of the cushioning material 306 is set to substantially the same size as that of the printing plate 302 or a larger size than that of the printing plate 302, for example. The cushioning material 306 is also arranged to substantially overlap the printing plate 302 that is adhered to the opposite surface of the support 304.

The arithmetic operation unit 18 also sets the types of the printing plate 302, the support 304, and the cushioning material 306 (for example, a material, a coefficient of elasticity, and a hardness) based on the type of the image of each color. To be more specific, the arithmetic operation unit 18 calculates the ratio between the area of the image and the area of the printing plate 302 (an area ratio) based on the image data of each color, and calculates a pressure applied to each pixel region of the printing plate 302 based on the area ratio and the size of the cushioning material 306. The arithmetic operation unit 18 also identifies the features of an image formed on each printing plate 302 from the analysis of the image of each color, and classifies the image into a line image, a solid area-dominated image, an image focusing on tone reproduction or the like. The arithmetic operation unit 18 then determines the optimum types of the printing plate 302 and the cushioning material 306 based on the image classification result from the property data of the printing plate 302 in the printing plate DB 24 and the property data of the cushioning material 306 in the cushioning material DB 26.

For example, when the area ratio of a fine design (for example, characters and line images) in the image formed on the printing plate 302 reaches a predetermined value or more, a printing plate 302 having a relatively high hardness (for example, a shore A hardness of 35 to 80 degrees) and a cushioning material 306 having a relatively low hardness (for example, a shore A hardness of 3 to 50 degrees) are employed to reduce expansion of the design. When the area ratio of a solid area reaches a predetermined value or more, a printing plate 302 having a relatively low hardness (for example, a shore A hardness of 20 to 50 degrees) and a cushioning material 306 having a relatively high hardness (for example, a shore A hardness of 20 to 60 degrees) are employed to reduce ink blur in the solid area.

Conventionally, a print operator determines the material of the cushioning material 306 or the like from his or her experience based on the features of the image (solidly printing characters, increasing the ink concentration in a solid area, reproducing an image with gradation, or the like) and the ratio of applying ink (the area ratio). If a trial print yields a poor result, it is necessary to perform adjustment again, which causes deterioration in productivity. According to the present embodiment, the cushioning material 306 can be automatically selected and the size thereof can be also automatically determined.

The image of each color created by the print design creation unit 16 is converted to exposure data for creating the printing plate 302 (for example, halftone dot data where gradation is represented by a group of dots), and is output to the plate-making apparatus (the exposure apparatus) 100 via the connection I/F 28. Note that the exposure data is created only for a region corresponding to the size of the printing plate 302 to expose only a required minimum region where the image is formed. Accordingly, an environmental impact can be minimized by improving the productivity of the printing plate 302, and keeping wastes produced by engraving the printing plate 302, exposure energy or the like to the minimum.

The arithmetic operation unit 18 respectively calculates the mounting position of the printing plate 302 on the exposure drum 102, and the mounting position of the printing plate 302 on the printing drum 202. The arithmetic operation unit 18 also acquires the respective mark information based on the model information of each of the plate-making apparatus (the exposure apparatus) 100 used for making the printing plate 302 and the printing apparatus 200. The arithmetic operation unit 18 then calculates the position of a plate-making positioning mark M30 for performing positioning according to a mounting mark M10 formed on the exposure drum 102 based on the mounting position of the printing plate 302 on the exposure drum 102, and also calculates the position of a printing positioning mark M32 for performing positioning according to a mounting mark M20 formed on the printing drum 202 based on the mounting position of the printing plate 302 on the printing drum 202 based on the acquired mark information.

The printer 20 is an inkjet printer, for example. The printer 20 prints the plate-making positioning mark M30 and the printing positioning mark M32 on the support 304 on which the printing plate 302 is mounted. The printer 20 also prints a mark (for example, an outline) indicating an adhesion position for adhering the printing plate 302 and the cushioning material 306, and information specifying the types of the printing plate 302 and the cushioning material 306 on the support 304. The content to be printed on the support 304 specifically includes the mounting positions and sizes of the printing plate 302 and the cushioning material 306 (for example, an outline and an orientation), the types thereof (for example, the printing plate: type A, the cushioning material: type 5), the plate-making positioning mark M30 and the printing positioning mark M32 (for example, a trim mark), and a position designation code indicating the mounting mark (reference lines or auxiliary reference lines described below) to be positioned with the plate-making positioning mark M30 and the printing positioning mark M32 (for example, “0-0” when the positioning mark M30 or M32 is matched with the reference lines, and “1-1” when the positioning mark M30 or M32 is matched with the first auxiliary reference lines respectively from the reference lines in X and Y directions).

### [Configuration of Plate-Making Apparatus (Exposure Apparatus) 100]

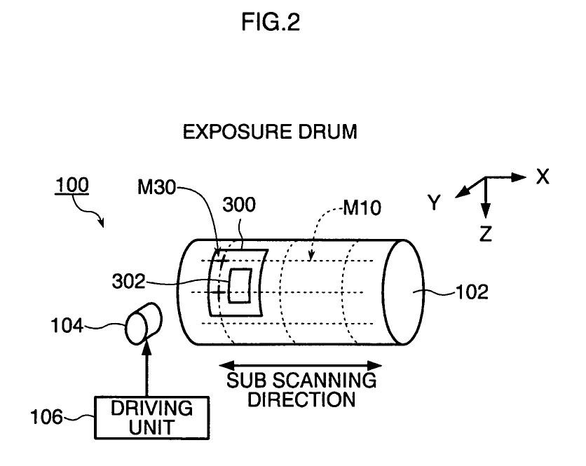

FIG. 2 is a perspective view illustrating the plate-making apparatus (the exposure apparatus) according to one embodiment of the present invention.

As shown in FIG. 2, the plate-making apparatus (the exposure apparatus) 100 according to the present embodiment includes the exposure drum 102, a laser head 104 which emits a laser beam, and a driving unit 106 which moves the laser head 104 in a sub scanning direction (the X direction in the drawing).

The mounting mark M10 as a reference for positioning when the printing plate 302 is mounted is formed on the surface of the exposure drum 102. The mounting mark M10 includes reference lines determined based on the original point of the exposure position of the laser head 104, and auxiliary reference lines formed at predetermined intervals from the reference lines. The reference lines and the auxiliary reference lines are formed in the circumferential direction (the rotational direction) of the exposure drum 102 and the direction perpendicular to the circumferential direction, for example.

For example, an apparatus of laser engraving type which uses a laser beam to remove a portion of the material of the printing plate (for example, a rubber plate) by ablation to thereby form concavity and convexity corresponding to an image, or an apparatus of black layer type which forms concavity and convexity corresponding to an image by forming a mask on the surface of a photosensitive layer (for example, a ultraviolet curable resin plate), emitting an infrared laser beam to remove a portion of the mask, emitting ultraviolet rays through the portion where the mask is removed to harden a portion of the photosensitive layer, and removing a portion except the hardened portion of the photosensitive layer may be applied as the plate-making apparatus (the exposure apparatus) 100.

### [Configuration of Printing Apparatus 200]

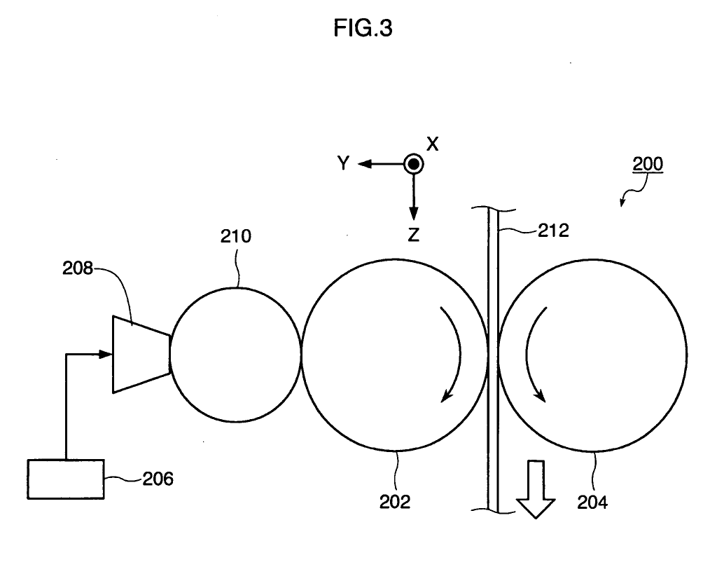

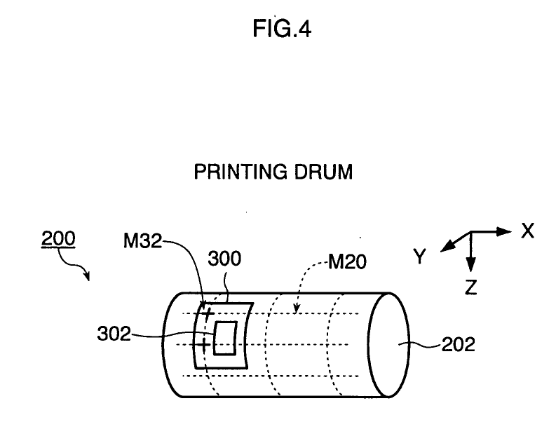

FIG. 3 is a view illustrating the printing apparatus according to one embodiment of the present invention. FIG. 4 is a perspective view of the printing drum of the printing apparatus according to one embodiment of the present invention.

As shown in FIG. 3, the printing apparatus 200 according to the present embodiment includes the printing drum (a cylinder) 202, an impression cylinder 204 which presses the object to be printed 212 against the printing drum 202 and rotates with the printing drum 202 to move the object to be printed 212, an ink tank 206 which stores ink, a doctor chamber 208 which supplies the ink stored in the ink tank 206 to an anilox roll 210, and the anilox roll 210 which applies the supplied ink to the printing plate 302 mounted on the printing drum 202.

The mounting mark M20 as a reference for positioning when the printing plate 302 is mounted is formed on the surface of the printing drum 202. The mounting mark M20 includes reference lines formed at positions corresponding to the edge corner of the object to be printed 212 or positions at predetermined intervals from the edge corner, and auxiliary reference lines formed at predetermined intervals from the reference lines. The reference lines and the auxiliary reference lines are formed in the circumferential direction (the rotational direction) of the printing drum 202 and the direction perpendicular to the circumferential direction, for example.

### [Configuration of Printing Plate Structure 300]

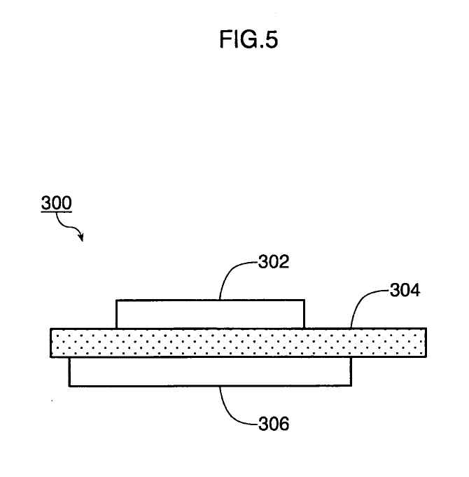

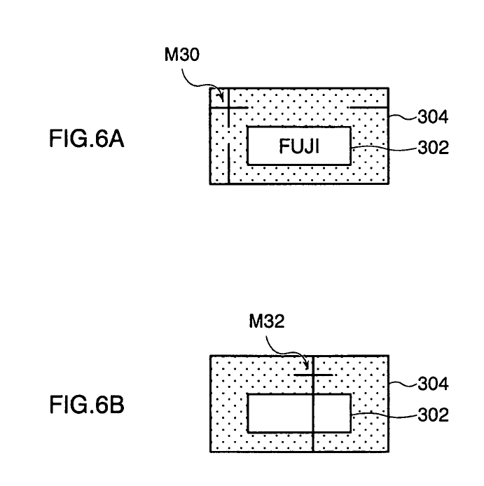

FIG. 5 is a side view illustrating a printing plate structure 300 according to one embodiment of the present invention. FIGS. 6A and 6B are plan views thereof.

As shown in FIG. 5, the printing plate structure 300 according to the present embodiment includes the printing plate 302 and the cushioning material 306 adhered to the both surfaces of the support 304. As shown in FIG. 5, the size of the printing plate 302 is smaller than that of the support 304. Also, the size of the cushioning material 306 is set to substantially the same size as that of the printing plate 302 or a larger size than that of the printing plate 302, and the cushioning material 306 is arranged to substantially overlap the printing plate 302.

A method of adhering the printing plate 302, the support 304 and the cushioning material 306 together with an adhesive or a double-sided tape and performing pressure bonding using a roller or the like may be used as a method for adhering the printing plate 302, the support 304 and the cushioning material 306 together.

The support 304 to which the printing plate 302 is adhered is used for photographic processing and printing after being exposed. Thus, a material which is not peeled away and deformed in these processes is used for the support and the adhesive agent.

For example, a photosensitive resin plate member including polyamide, polyvinyl alcohol (including partially saponified vinyl acetate), polyurethane, styrene-butadiene rubber, styrene-isoprene rubber, chloroprene rubber, ethylene-propylene rubber, silicone rubber or the like in a photosensitive layer, a rubber plate member, or a combination thereof may be used as the printing plate 302.

For example, aluminum and polyester resin may be used as the support 304.

For example, a member having elasticity (an elastic recovery force) such as foamed synthetic rubber, foamed natural rubber, foamed polyurethane, and photosensitive resin hardened by exposure to ultraviolet rays, or a combination thereof may be used as the cushioning material 306.

As shown in FIGS. 6A and 6B, the plate-making positioning mark M30 for performing positioning according to the mounting mark M10 formed on the exposure drum 102 and the printing positioning mark M32 for performing positioning according to the mounting mark M20 formed on the printing drum 202 based on the mounting position of the printing plate 302 on the printing drum 202 are separately printed on the surface of the support 304. One mark may be used for both the marks M30 and M32.

### [Mounting of Printing Plate]

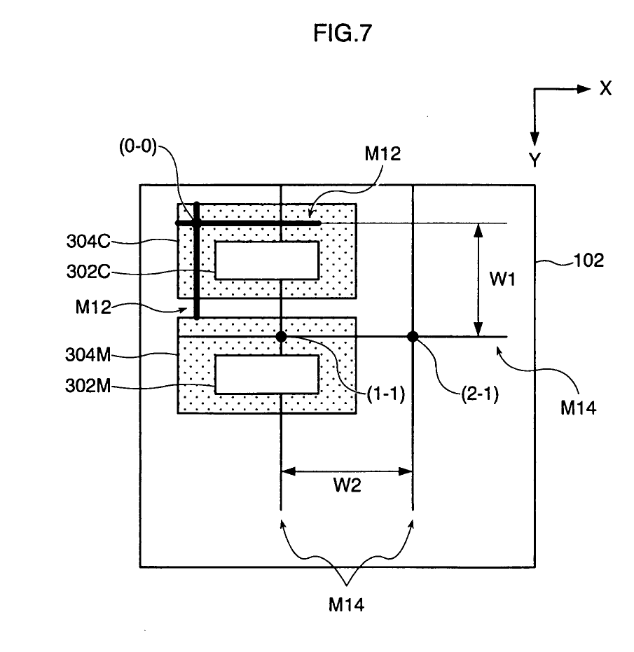

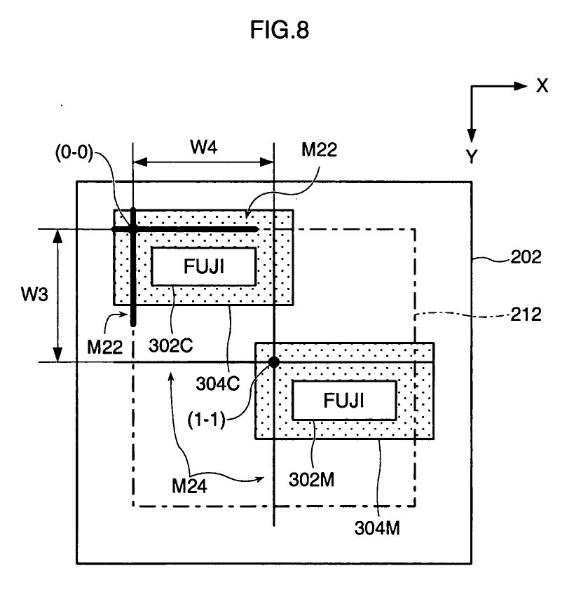

FIG. 7 is a plan view illustrating a state in which the printing plate structure 300 is mounted on the exposure drum 102. FIG. 8 is a plan view illustrating a state in which the printing plate structure 300 is mounted on the printing drum 202.

FIGS. 7 and 8 illustrate the positional relationship among the printing plates 302, the supports 304, the mounting marks of the exposure drum 102 and the printing drum 202, and the positioning marks of the supports 304 when “FUJI” is printed on positions apart from each other on the object to be printed 212 with the inks of cyan and magenta.

As shown in FIG. 7, reference lines M12 and a plurality of auxiliary reference lines M14 arranged at predetermined intervals (W1 and W2) from the reference lines M12 in a lattice pattern are formed as the mounting mark M10 on the surface of the exposure drum 102. As shown in FIG. 8, reference lines M22 and a plurality of auxiliary reference lines M24 arranged at predetermined intervals (W3 and W4) from the reference lines M22 in a lattice pattern are formed as the mounting mark M20 on the surface of the printing drum 202.

When the printing plate structure 300 is mounted on the printing drum 202, the printing positioning mark M32 printed on the support 304 is matched with the reference lines M22 or the auxiliary reference lines M24 designated by the position designation code that is printed on the support 304, so that the printing plate structure 300 can be accurately mounted. In the example shown in FIG. 8, a support 304C to which a printing plate 302C for forming the image of cyan is adhered is matched with the reference lines M22, and a support 304M to which a printing plate 302M for forming the image of magenta is adhered is matched with the first auxiliary reference lines M24 (“1-1”) respectively from the reference lines M22 in the X and Y directions.

Meanwhile, when the printing plate structure 300 is mounted on the exposure drum 102, the plate-making positioning mark M30 printed on the support 304 is matched with the reference lines M12 or the auxiliary reference lines M14 designated by the position designation code that is printed on the support 304, so that the printing plate structure 300 can be accurately mounted.

As shown in FIG. 7, when the printing plate structures 300 are mounted on the exposure drum 102, the printing plate structures 300 are adhered to increase the arrangement density thereof on the surface of the exposure drum 102. For example, the printing plate structures 300 are arranged so as to be lined in the rotational direction of the exposure drum 102, that is, so as to minimize the travel distance of the laser head 104 in the sub scanning direction.

As described above, it is preferable to separately set the plate-making positioning mark M30 and the printing positioning mark M32 in order to achieve the arrangement corresponding to a final print on the printing drum 202 and the optimum arrangement from the perspective of productivity on the exposure drum 102.

For example, a method of using various adhesives and pressure sensitive adhesives, and a method of providing a suction mechanism which sucks the printing plate structure 300 to the exposure drum 102 and the printing drum 202, a fixing mechanism which holds and fixes the printing plate structure 300, or the like may be applied as a method for adhering the printing plate structure 300 to the exposure drum 102 and the printing drum 202. Alternatively, a pin hole for positioning may be made in advance in the printing plate structure 300, and a fixing pin may be provided on each of the exposure drum 102 and the printing drum 202, thereby improving mounting accuracy and operability.

### [Method for Mounting Printing Plate]

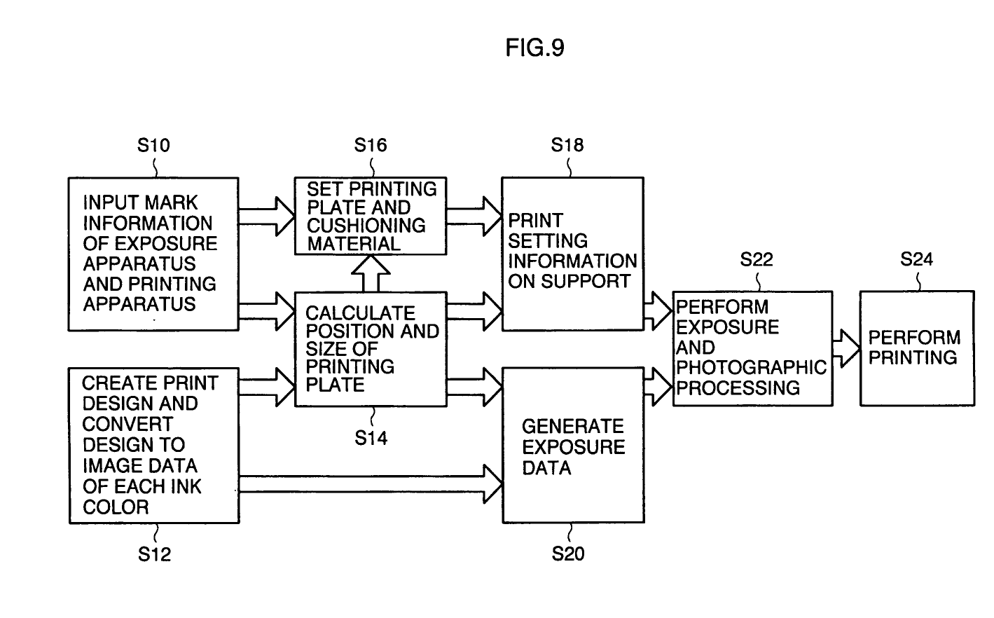

FIG. 9 is a flowchart illustrating a method for mounting a printing plate according to one embodiment of the present invention.

First, the mounting mark information of the exposure apparatus 100 and the printing apparatus 200 is input to the printing plate mounting apparatus 10 (step S10).

Subsequently, the print design to be printed on the object to be printed 212 is created in the print design creation unit 16 (step S12). In step S12, the print design corresponding to a three-dimensional shape obtained by building up the object to be printed is created. The image data of the print design is converted to image data of each ink color (for example, black (K), cyan (C), magenta (M), and yellow (Y)).

Subsequently, a developed view of the object to be printed 212 is calculated, and the position and size of an image formation region in the developed view is calculated for each ink color. The size of the printing plate 302 for forming the image in each image formation region is calculated based on the position and size of the image formation region. Note that the position of the printing plate 302 is calculated in consideration of the position of a fold line when the object to be printed is built up. The arrangement of the printing plate 302 on the exposure drum 102 at the time of forming the printing plate 302, and the arrangement of the printing plate 302 on the printing drum 202 at the time of printing the image by use of the printing plate 302 are calculated (step S14).

Subsequently, the type of the printing plate 302 and the size and type of the cushioning material 306 are set (step S16).

Subsequently, the setting information indicating the adhesion positions, sizes and types of the printing plate 302 and the cushioning material 306, the plate-making positioning mark M30 and the printing positioning mark M32 are output (printed) on the support 304 (step S18).

Subsequently, the image of each color is captured based on the data on the position and size of the printing plate 302, the image is adhered to the position based on the mounting mark of the exposure apparatus 100, and the exposure data (the halftone dot data) is generated based on the image corresponding to each printing plate 302, and is output to the exposure apparatus 100 via the connection I/F 28 on an image creation application of the print design creation unit 16 (step S20).

Subsequently, the image is exposed on the surface of the printing plate 302 adhered to the exposure drum 102 based on the exposure data, and the photographic processing is performed (step S22). In step S22, an unexposed printing plate 302 having a designated size is adhered to a position designated by the position designation code of the support 304, first. The support 304 of the printing plate structure 300 is positioned by use of the plate-making positioning mark M30, and is mounted on the surface of the exposure drum 102. Then, the exposure drum 102 and the laser head 104 are driven to expose the image on the surface of the printing plate 302, and the photographic processing is performed.

Subsequently, the printing plate 302 is mounted on the printing drum 202 of the printing apparatus 200 to print the image (step S24). In step S24, the cushioning material 306 designated by the setting information printed on the support 304 is adhered to the rear surface of the support 304, first. The printing plate structure 300 composed of the printing plate 302, the support 304 and the cushioning material 306 is positioned by use of the printing positioning mark M32, and is adhered to the surface of the printing drum 202. Then, the printing apparatus 200 is driven and the image is printed. An operator may perform fine adjustment of the printing position based on the printed result if necessary.

What is claimed is:

1. A printing plate mounting apparatus, comprising:
a mounting mark information acquiring device which acquires information of a mounting mark that is formed on each of a plate-making drum provided in a plate-making apparatus that makes a printing plate and a printing drum provided in a printing apparatus that prints an image on an object to be printed by using the printing plate;
an image creating device which creates an image of each color from the image to be printed on the object to be printed;
a first calculating device which respectively calculates a size of each printing plate corresponding to the image of each color and a mounting position of the printing plate on each of the plate-making drum and the printing drum;
a second calculating device which calculates a position of a plate-making positioning mark for performing positioning according to the mounting mark formed on the plate-making drum based on the mounting position of the printing plate on the plate-making drum, and also calculates a position of a printing positioning mark for performing positioning according to the mounting mark formed on the printing drum based on the mounting position of the printing plate on the printing drum; and
a printing device which prints the plate-making positioning mark and the printing positioning mark on a support on which the printing plate is mounted.

2. The printing plate mounting apparatus according to claim 1, wherein when the printing plate comprises a plurality of printing plates, the second calculating device sets the plate-making positioning mark so as to increase an arrangement density of the plurality of printing plates on the plate-making drum.

3. The printing plate mounting apparatus according to claim 1, wherein when the printing plate comprises a plurality of printing plates, the second calculating device sets the plate-making positioning mark so that the plurality of printing plates are lined in a rotational direction of the plate-making drum.

4. The printing plate mounting apparatus according to claim 1, wherein the printing device prints on the support a mark that indicates a position to mount the printing plate.

5. The printing plate mounting apparatus according to claim 1, further comprising: a size setting device which sets a size of a cushioning material which is mounted on the support based on the size of the printing plate,
wherein the printing device prints on the support a mark that indicates a position to mount the cushioning material.

6. The printing plate mounting apparatus according to claim 1, further comprising: a material setting device which sets a material of the printing plate and a material of a cushioning material which is mounted on the support based on a type of the image and an area ratio that is a ratio between an area of the image and an area of the printing plate,
wherein the printing device prints the material of the printing plate and the material of the cushioning material on the support.

7. A method for mounting a printing plate, comprising the steps of:
a mounting mark information acquiring step of acquiring information of a mounting mark that is formed on each of a plate-making drum provided in a plate-making apparatus that makes a printing plate and a printing drum provided in a printing apparatus that prints an image on an object to be printed by using the printing plate;
an image creating step of creating an image of each color from the image to be printed on the object to be printed;
a first calculating step of respectively calculating a size of each printing plate corresponding to the image of each color and a mounting position of the printing plate on each of the plate-making drum and the printing drum;
a second calculating step of calculating a position of a plate-making positioning mark for performing positioning according to the mounting mark formed on the plate-making drum based on the mounting position of the printing plate on the plate-making drum, and also calculating a position of a printing positioning mark for performing positioning according to the mounting mark formed on the printing drum based on the mounting position of the printing plate on the printing drum; and
a printing step of printing the plate-making positioning mark and the printing positioning mark on a support on which the printing plate is mounted.

8. The method for mounting a printing plate according to claim 7, wherein in the second calculating step, when the printing plate comprises a plurality of printing plates, the plate-making positioning mark is set so as to increase an arrangement density of the plurality of printing plates on the plate-making drum.

9. The method for mounting a printing plate according to claim 7, wherein in the second calculating step, when the printing plate comprises a plurality of printing plates, the plate-making positioning mark is set so that the plurality of printing plates are lined in a rotational direction of the plate-making drum.

10. The method for mounting a printing plate according to claim 7, wherein in the printing step, a mark that indicates a position to mount the printing plate is printed on the support.

11. The method for mounting a printing plate according to claim 7, further comprising: a size setting step of setting a size of a cushioning material which is mounted on the support based on the size of the printing plate,
wherein in the printing step, a mark that indicates a position to mount the cushioning material is printed on the support.

12. The method for mounting a printing plate according to claim 7, further comprising: a material setting step of setting a material of the printing plate and a material of a cushioning material which is mounted on the support based on a type of the image and an area ratio that is a ratio between an area of the image and an area of the printing plate,
wherein in the printing step, the material of the printing plate and the material of the cushioning material are printed on the support.
